(19) United States
(12) Patent Application Publication
(10) Pub. No.: US 2025/0299106 A1
(43) Pub. Date: Sep. 25, 2025

(54) AUTOMATED MACHINE LEARNING PIPELINE DEPLOYMENT

(71) Applicant: ResMed Digital Health Inc., San Diego, CA (US)

(72) Inventors: Philomena Schlexer Lamoureux, Encinitas, CA (US); Ahmed Abid, San Diego, CA (US); Ronald Evan Catain Melencio, Sunnyvale, CA (US); Jason Matthew Carpenter, Seattle, WA (US); Yuan Yongshan, Singapore (SG); Prakhar Shukla, San Diego, CA (US); Christopher Bernard Flesche, Plymouth, MN (US)

(21) Appl. No.: 19/106,185

(22) PCT Filed: Aug. 23, 2023
(86) PCT No.: PCT/US2023/072740

§ 371 Date: Feb. 24, 2025

Related U.S. Application Data
(60) Provisional application No. 63/400,289, filed on Aug. 23, 2022.
(60) Provisional application No. 63/400,306, filed on Aug. 23, 2022.

(51) Int. Cl. G06N 20/00

(52) U.S. Cl. CPC G06N 20/00

(57) ABSTRACT

Techniques for self-serve machine learning are provided. A request to deploy a machine learning model is received, where the request specifies whether to deploy the machine learning model for batch inferencing or real-time inferencing. In response to determining that a deployment pipeline for the machine learning model is not available, a deployment pipeline is instantiated for the machine learning model, comprising: retrieving a machine learning model definition from a registry containing trained machine learning model definitions, validating the machine learning model definition using one more test exemplars, and instantiating an inferencing pipeline including the machine learning model. Input data is processed using the inferencing pipeline.

### CROSS-REFERENCE TO RELATED APPLICATIONS

This Application claims the benefit of and priority to U.S. Provisional Patent Application No. 63/400,289, filed on Aug. 23, 2022, and to U.S. Provisional Patent Application No. 63/400,306, filed on Aug. 23, 2022, the entire content of each of which are incorporated herein by reference.

### INTRODUCTION

Embodiments of the present disclosure relate to machine learning. More specifically, embodiments of the present disclosure relate to automatic self-serve machine learning pipelines.

Increasingly, artificial intelligence (AI) and machine learning (ML) have been used in a wide variety of deployments and solutions to perform an assortment of tasks. For example, ML models have been trained and used to perform speech recognition, image classification, outcome prediction for various events or occurrences, and the like. In conventional systems, the actual process of designing, training, and deploying the model architecture is laborious, tedious, time-consuming, and complex. For example, data scientists must manually define the model architecture, manually perform a variety of operations and processes to instantiate the training process, manually train (or supervise the training), manually evaluate the resulting model, manually perform a variety of operations and processes to instantiate the model for deployment, and finally deploy the model. Each step of these processes involves significant complexity, requiring attention from highly-trained data scientists, and adds delay or lag to the operation, as well as potentially introducing human errors or mistakes.

Accordingly, AI and ML systems are severely limited in their uses and deployments, as the actual process of training and deploying them is laborious and difficult. Improved systems and techniques to provide automated model training and deployment are needed.

### SUMMARY

According to one embodiment presented in this disclosure, a method is provided. The method includes: receiving a request to deploy a machine learning model, wherein the request specifies whether to deploy the machine learning model for batch inferencing or real-time inferencing; in response to determining that a deployment pipeline for the machine learning model is not available, instantiating a deployment pipeline for the machine learning model, comprising: retrieving a machine learning model definition from a registry containing trained machine learning model definitions; validating the machine learning model definition using one more test exemplars; and instantiating an inferencing pipeline including the machine learning model; and processing input data using the inferencing pipeline.

According to one embodiment presented in this disclosure, a system is provided. The system comprises: a memory comprising computer-executable instructions; and one or more processors configured to execute the computer-executable instructions and cause the processing system to perform an operation comprising: receiving a request to deploy a machine learning model, wherein the request specifies whether to deploy the machine learning model for batch inferencing or real-time inferencing; in response to determining that a deployment pipeline for the machine learning model is not available, instantiating a deployment pipeline for the machine learning model, comprising: retrieving a machine learning model definition from a registry containing trained machine learning model definitions; validating the machine learning model definition using one more test exemplars; and instantiating an inferencing pipeline including the machine learning model; and processing input data using the inferencing pipeline.

According to one embodiment presented in this disclosure, a non-transitory computer-readable medium is provided, comprising computer-executable instructions that, when executed by one or more processors of a processing system, cause the processing system to perform an operation comprising: receiving a request to deploy a machine learning model, wherein the request specifies whether to deploy the machine learning model for batch inferencing or real-time inferencing; in response to determining that a deployment pipeline for the machine learning model is not available, instantiating a deployment pipeline for the machine learning model, comprising: retrieving a machine learning model definition from a registry containing trained machine learning model definitions; validating the machine learning model definition using one more test exemplars; and instantiating an inferencing pipeline including the machine learning model; and processing input data using the inferencing pipeline.

According to one embodiment presented in this disclosure, a method is provided. The method includes: receiving a request to perform continuous learning for a machine learning model, wherein the request specifies retraining logic comprising one or more triggering criteria; automatically instantiating an inferencing pipeline including the machine learning model; automatically instantiating the retraining logic, including the one or more triggering criteria; processing input data using the inferencing pipeline; and in response to determining that the one or more triggering criteria are satisfied, automatically: using the retraining logic to retrieve new training data from a designated repository; and using the retraining logic to generate a refined machine learning model by training the machine learning model using the new training data.

According to one embodiment presented in this disclosure, a system is provided. The system comprises: a memory comprising computer-executable instructions; and one or more processors configured to execute the computer-executable instructions and cause the processing system to perform an operation comprising: receiving a request to perform continuous learning for a machine learning model, wherein the request specifies retraining logic comprising one or more triggering criteria; automatically instantiating an inferencing pipeline including the machine learning model; automatically instantiating the retraining logic, including the one or more triggering criteria; processing input data using the inferencing pipeline; and in response to determining that the one or more triggering criteria are satisfied, automatically: using the retraining logic to retrieve new training data from a designated repository; and using the retraining logic to generate a refined machine learning model by training the machine learning model using the new training data.

According to one embodiment presented in this disclosure, a non-transitory computer-readable medium is provided, comprising computer-executable instructions that, when executed by one or more processors of a processing system, cause the processing system to perform an operation comprising: receiving a request to perform continuous learning for a machine learning model, wherein the request specifies retraining logic comprising one or more triggering criteria; automatically instantiating an inferencing pipeline including the machine learning model; automatically instantiating the retraining logic, including the one or more triggering criteria; processing input data using the inferencing pipeline; and in response to determining that the one or more triggering criteria are satisfied, automatically: using the retraining logic to retrieve new training data from a designated repository; and using the retraining logic to generate a refined machine learning model by training the machine learning model using the new training data.

The following description and the related drawings set forth in detail certain illustrative features of one or more embodiments.

### DESCRIPTION OF THE DRAWINGS

The appended figures depict certain aspects of the one or more embodiments and are therefore not to be considered limiting of the scope of this disclosure.

FIG. 1 depicts an example environment for improved artificial intelligence/machine learning pipelines.

FIG. 2 depicts an example architecture for automated self-serve machine learning pipelines.

FIG. 3 depicts an example workflow for self-serve machine learning model deployment.

FIG. 4 depicts an example workflow for automated continuous learning pipeline deployment.

FIG. 5 is a flow diagram depicting an example method for self-serve machine learning deployment.

FIG. 6 is a flow diagram depicting an example method for real-time inferencing using automatically deployed models.

FIG. 7 is a flow diagram depicting an example method for batch inferencing using automatically deployed models.

FIG. 8 is a flow diagram depicting an example method for automated continuous learning deployment.

FIG. 9 is a flow diagram depicting an example method for automatically training machine learning models using deployed pipelines.

FIG. 10 is a flow diagram depicting an example method for automatically deploying machine learning models.

FIG. 11 is a flow diagram depicting an example method for automatically performing continuous learning of machine learning models.

FIG. 12 depicts an example computing device configured to perform various aspects of the present disclosure.

Additional aspects of the present disclosure can be found in the attached appendix.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automated machine learning operations. For example, in some embodiments, techniques and architectures are provided to enable automated (e.g., self-serve) deployment of machine learning models based on simple definitions, rather than requiring complex configurations and deep technical understanding. In some embodiments, techniques and architectures are provided to enable automated (e.g., self-serve) training and continuous learning of machine learning models based on similar simple definitions (as opposed to the complex configurations and technical understanding needed in conventional systems).

In conventional systems, users (e.g., data scientists or engineers) are required to manually construct the needed infrastructure to train and use machine learning models. For example, the user may set up a container or computing instance, run microservices, and the like. Further, in many conventional systems, only certain users or entities (e.g., those logged into production accounts) are able to perform a variety of the operations needed to instantiate or deploy trained models.

In aspects of the present disclosure, a user can instead simply provide, to the automated system, a model definition and/or configuration file (e.g., indicating whether the model should be deployed as a real-time inferencing endpoint or a batch inferencing endpoint). The system can then automatically instantiate any needed infrastructure, perform any relevant operations or evaluations (e.g., validating the model), and deploy and/or train the model according to the configuration. This substantially reduces the time, effort, and expertise needed to work with and deploy machine learning models, enabling ML to be used for broader and more far-ranging solutions that are otherwise too niche to justify the effort. Further, some aspects of the present disclosure readily provide rapid continuous learning and automated updating, ensuring continued success and improved model accuracy. Additionally, aspects of the present disclosure can reduce human error in the process, thereby resulting in more reliable and accurate computing systems. Moreover, some aspects of the present disclosure can automatically re-use infrastructure intelligently and dynamically when relevant, thereby reducing the computational burden of the training and/or deployment process (as compared to conventional solutions where users manually perform the processes and seldom or never re-use previous infrastructure).

As used herein, a “pipeline” generally refers to a set of components, operations, and/or processes used to perform a task. For example, a deployment pipeline may refer to a set of components, operations, and/or processes to deploy a machine learning model for inferencing. An inferencing pipeline may refer to a set of components, operations, and/or processes to perform inferencing using a machine learning model. A training pipeline may refer to a set of components, operations, and/or processes to train or refine machine learning models based on training data. Aspects of the present disclosure provide for automated deployment and use of such pipelines to perform self-serve machine learning (e.g., inferencing and/or training).

In some embodiments, automated machine learning model deployment (referred to as self-serve machine learning in some aspects) is provided. In one embodiment, a deployment request or submission can be received, from a user, to instantiate a model for inferencing. This request may specify, for example, the model architecture or definition, whether the model should be deployed as a batch-inferencing system or a real-time inferencing system, how to access the input data and/or where to provide the output, and the like. In one embodiment, if a deployment pipeline exists for the architecture, the system can re-use this existing pipeline to deploy the model. If no such pipeline exists, the system can instantiate one.

In at least one embodiment, as discussed above, deploying the deployment pipeline (also referred to as instantiating, generating, or creating the pipeline) can include instantiating a set of components or processes to perform the sequence of operations needed to deploy the model. The deployment pipeline can then be used to actually deploy the model (e.g., to instantiate an inferencing pipeline for the model). In some embodiments, the deployment pipeline is used to retrieve the model definition and configuration (from the request, or from a registry, as discussed in more detail below), optionally validate the model (e.g., to confirm that it behaves deterministically), and finally to actually instantiate a new endpoint or inferencing pipeline to serve the model to users.

In an embodiment, when input is ready for processing (e.g., when a user provides input data for real-time inferencing, and/or when batch data is ready for processing), the system processes the input using the instantiated inferencing pipeline. As discussed above, deploying the inferencing pipeline can include instantiating a set of components or processes to perform the sequence of operations needed to process input data using the model. For example, the inferencing pipeline may optionally perform preprocessing on the input data, pass the data through the model to generate an output, and return the output accordingly. In this way, the system provides rapid and automated deployment of trained models for inferencing.

In some embodiments, automated continuous learning of machine learning models (referred to as self-serve training and/or continuous learning in some aspects) is provided. In one such embodiment, a request can be received, from a user, to instantiate a continuous learning pipeline. For example, the request may include a training script/container (e.g., defining how the training should be performed), a continuous training configuration file (e.g., a re-training schedule or criteria), and a model deployment configuration file (e.g., the configuration file used to define how the model is deployed for inferencing, such as whether to use real-time or batch inferencing).

In an embodiment, the training container can be retrieved or provided into a central location and a training schedule can be instantiated (e.g., subscribing to an input table update, or using a timer or other triggering criteria). In some embodiments, a training pipeline can be deployed and used immediately when the submission/request is received. This training pipeline generates/trains a machine learning model based on the provided architecture. For example, in one embodiment, the training pipeline can retrieve the new training data (e.g., from a defined storage location or database, as indicated in the request), refine the model using the data, and store the refined model in a model registry. In some aspects, the model is stored with an associated label or flag indicating that it is ready for deployment, along with the model deployment configuration file (which may be provided in the request).

In some embodiments, storing the model in the registry with this flag can automatically initiate the deployment process, as discussed above. The deployed model can then be used for inferencing, as discussed above.

In embodiments, the model inferencing may have an independent schedule from the continuous training pipeline. Similarly, new (refined) models can be deployed as different versions (enabling model versioning), such that it is possible to have several different model versions in production (e.g., until older models are retired).

In an embodiment, when triggering criteria for retraining are satisfied, a retraining logic and/or pipeline and the relevant configuration files (from the request) can be used to perform the retraining as discussed above, such as by accessing the training container and the configurations from the central location (and file locations referenced therein) and retrieving the new data. This process may then repeat indefinitely to continuously provide newly-refined models.

### Example Environment for Artificial Intelligence/Machine Learning Pipelines

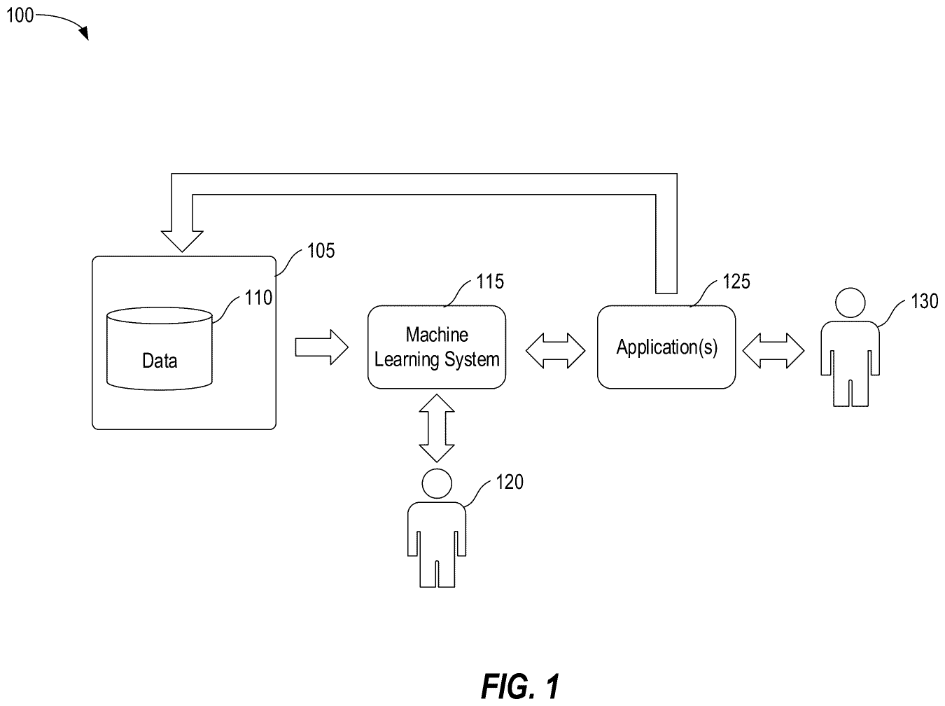

FIG. 1 depicts an example environment 100 for improved artificial intelligence/machine learning pipelines.

In the illustrated environment 100, a machine learning system 115 is communicatively linked with a data repository 105 and one or more applications 125. In embodiments, the data repository 105, machine learning system 115, and applications 125 may be coupled using any suitable technology. The connection may include wireless connections, wired connections, or a combination of wired and wireless connectivity. In at least one aspect, the data repository 105, machine learning system 115, and applications 125 are communicatively coupled via the Internet.

Although a single data repository 105 is depicted for conceptual clarity, in embodiments, there may be any number of such repositories. Additionally, though depicted as a discrete component for conceptual clarity, in some embodiments, the data repository 105 may be implemented or stored within other components, such as within the machine learning system 115 and/or applications 125.

In the illustrated example, the data repository 105 stores data 110. The data 110 can generally correspond to a wide variety of data, such as training data for machine learning models, input data (e.g., for batch inferencing) during runtime, output data (e.g., generated inferences), and the like. As illustrated, the machine learning system 115 uses the data 110 in conjunction with one or more machine learning models. For example, as discussed in more detail below, the machine learning system 115 may retrieve or access data 110 to train or refine machine learning models using an automated training and/or continuous learning pipeline. Similarly, as discussed in more detail below, the machine learning system 115 may retrieve or access data 110 as input to automated inferencing pipelines.

As illustrated, user(s) 120 can interact with the machine learning system 115 to perform a variety of machine learning-related tasks. For example, the users 120 may be data scientists, engineers, or other users that wish to train and/or deploy machine learning models. In some embodiments, the users can provide requests or submissions to the machine learning system 115 to trigger automated instantiation and/or deployment of machine learning models and training pipelines, as discussed below in more detail.

In some aspects, a user 120 may indicate a model definition (either included in the request, or included as a pointer to the model, which may be stored in a registry, such as in the data repository 105), along with a configuration specifying how the model should be deployed. For example, the configuration may indicate that the model should be run in batch mode, as well as the specific storage location (e.g., a particular table or other storage structure in the data repository 105) where the input data can be accessed, and/or a specific storage location (e.g., a particular table or other storage structure in the data repository 105) where the output data should be stored. In response, the machine learning system 115 may automatically deploy the model accordingly.

Similarly, in some aspects, a user 120 may indicate a model definition and a training configuration, allowing the machine learning system 115 to automatically instantiate the training process. For example, the configuration may specify where the training data will be stored (e.g., a particular table or other storage structure in the data repository 105), what the training criteria are (e.g., whether re-training should be performed whenever new data is available at the location, when a certain amount of data or exemplars are available, when a defined period has elapsed, and the like), whether the machine learning system 115 should automatically deploy the newly-refined models, whether newly-refined models should supplant the prior model (e.g., whether the prior inferencing pipeline should be closed when the new one is created), and the like.

In the illustrated embodiment, a set of application(s) 125 can interface with the machine learning system 115 for a variety of purposes. For example, an application 125 may use trained machine learning models to generate predictions or suggestions for users 130. In embodiments, the applications 125 may use the model(s) locally (e.g., the machine learning system 115 may deploy them to the application 125), or may access the models hosted by the machine learning system 115 (e.g., using an application programming interface (API)). In embodiments, the applications 125 may themselves be hosted in any suitable location, including on user devices (e.g., on personal devices of the user(s) 130), in a cloud-based deployment (accessible via user devices), and the like.

As illustrated, the applications 125 can optionally transmit data to the data repository 105. For example, for batch inferencing, users 130 may use an application 125 to provide or store the input data at the appropriate location in the data repository 105 (where the application 125 may know the appropriate location based on the configuration used to instantiate the model, as discussed above). The machine learning system 115 can then automatically retrieve the data and process it to generate output data, as discussed above. In some embodiments, the applications 125 may similarly use the data repository 105 to provide input data for real-time inferencing. In other aspects, the applications 125 may directly provide the input data to the machine learning system 115 for real-time inferencing.

In some embodiments, the machine learning system 115 can provide the data directly to the requesting user 130. For example, the machine learning system 115 may provide the generated output to the application(s) 125 that provided the input data. In some embodiments, the machine learning system 115 stores the output data at the appropriate location in the data repository 105, allowing the applications 125 to retrieve or access it.

In at least one embodiment, some or all of the applications 125 can be used to provide or enable continuous learning. In one such embodiment, the applications 125 may store labeled exemplars in the data repository 105 when the labels become known. For example, after generating an inference using input data (e.g., a predicted future value for a variable, based on current data), an application 125 may subsequently determine the actual value for the variable. This actual value can then be used as the label for the prior data used to generate the inference, and the labeled exemplar can be stored in the data repository 105 (e.g., in the location used for continuous training of the model). This can allow the machine learning system 115 to automatically retrieve it and use it for refining the models, as discussed above.

### Example Architecture for Automated Self-Serve Machine Learning Pipelines

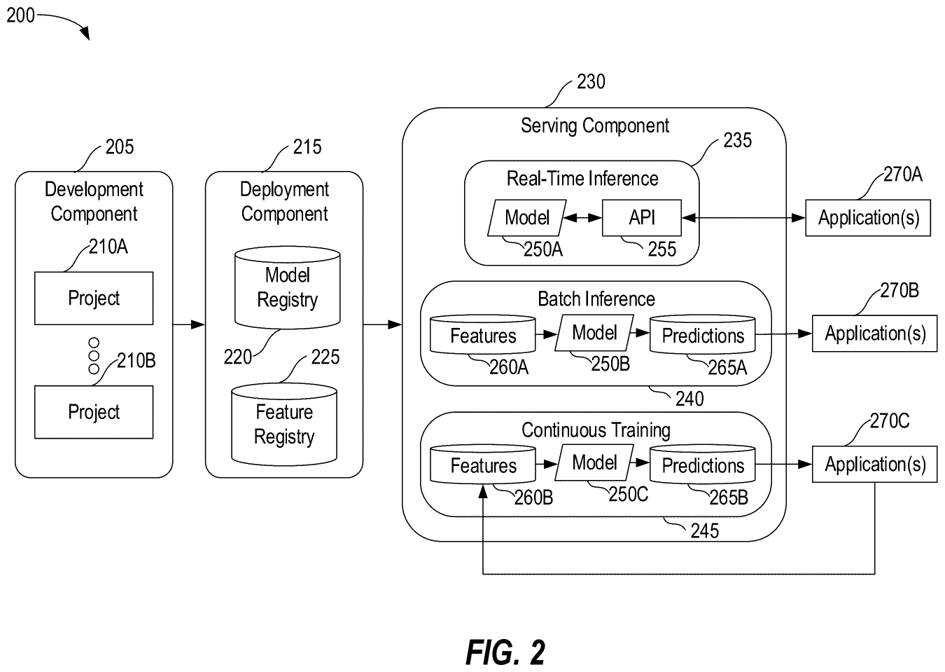

FIG. 2 depicts an example architecture 200 for automated self-serve machine learning pipelines. The architecture shows one example implementation of a machine learning system, such as the machine learning system 115 of FIG. 1. Although the depicted example includes a variety of discrete components for conceptual clarity, the operations of each component may be performed collectively or independently by any number of components.

In the illustrated example, a development component 205 is used (e.g., by users 120 of FIG. 1) to define machine learning models. In one embodiment, each project 210A-B in the development component 205 may correspond to an ongoing machine learning project. For example, the project 210A may correspond to a data scientist developing a machine learning model to classify images based on what they depict, while the project 210B may correspond to a data scientist developing a machine learning model to identify spoken keywords in audio data. Generally, the development component 205 may be implemented using any suitable technology, and may reside in any suitable location. For example, the development component 205 may correspond to one or more discrete computing devices used by users to develop models, may correspond to an application or interface of the machine learning system, and the like.

In an embodiment, users may use the development component 205 to define the architecture of the model, the configuration of the mode, and the like. For example, using the development component 205, a user may create a project 210 to train a specific model architecture (e.g., a neural network). Using the development component 205, the user may specify information such as the hyperparameters of the model (e.g., the number of layers, the learning rate, and the like), as well as information relating to the features used, preprocessing they want to apply to input data, and the like. In some embodiments, the development component 205 may similarly be used, by the user(s), to perform operations such as data exploration (e.g., investigating the potential data sources for the model), feature engineering, and the like.

In the illustrated example, when a model architecture is ready to begin training and/or when the model is ready for deployment, the deployment component 205 can provide the relevant data to the deployment component 215. For example, the user may provide a submission including the model architecture or definition, the configuration file(s), and the like, to the deployment component 215.

In the illustrated example, the deployment component 215 includes a model registry 220 and a feature registry 225. Although depicted as discrete components for conceptual clarity, in some aspects, the model registry 220 and feature registry 225 may be combined into a single registry or data store. In one embodiment, the model registry 220 is used to store the model definition(s) and/or configuration file(s) defined using the development component 205. For example, the user may provide the model definition (e.g., indicating the architecture, hyperparameters, and the like) for a given project 210 as a submission to the deployment component 215, which stores it in the model registry 220. In some embodiments, the deployment component 215 can also store the provided configuration with the model definition in the model registry 220 (e.g., specifying whether to instantiate the model as a real-time inference model or a batch inference model).

In some embodiments, a flag, label, tag, or other indication can also be stored with the model in the model registry 220. As discussed above, this flag can be used to indicate whether the model is ready for training and/or deployment. For example, the user may set the flag or otherwise cause the model registry 220 to be updated when relevant, such as when the architecture is ready to begin training, when the model is trained and ready for deployment, and the like.

In an embodiment, the feature registry 225 may include information relating to features and/or preprocessing that can be applied to models. For example, the feature registry 225 may include definitions for data transformers or other components that can be used to clean, normalize, or otherwise preprocess input data.

As illustrated, the deployment component 215 is coupled with a serving component 230. The serving component 230 can generally access the definitions and configurations in the model registry 220 to instantiate pipelines 235, 240, and/or 245. For example, based on user submission (or based on the flag associated with a model in the model registry 220), the machine learning system 115 may automatically retrieve the model definition and configuration, and use it to instantiate a corresponding pipeline.

As one example, if the configuration of a give model (or the configuration included in a user request or submission) indicates that the model should be instantiated for real-time inferencing, the serving component 230 may generate a real-time inference pipeline 235. As another example, based on the submission, request, and/or tags, the serving component 230 can additionally or alternatively instantiate a batch inference pipeline 240 and/or a continuous training pipeline 245.

In the illustrated example, the real-time inference pipeline 235 includes a copy or instance of the model 250A, as well as an API 255 that can be used to enable or provide access to the model 250A (e.g., to application(s) 270A). For example, the application 270A may use the API 255 to provide input data to the real-time inference pipeline 235, which then processes it with the model 250A to generate an output inference. This output can then be returned, via the API 255, back to the application 270.

In the depicted example, the batch inference pipeline 240 includes a feature store 260A, a copy or instance of the model 250B, and a predictions store 265A. For example, the application(s) 270B or other entities may provide input data, to be processed in batches, which can be stored in the features 260A. When the appropriate triggering criteria are met (e.g., defined in the configuration), the batch inference pipeline 240 retrieves the data, processes it with the model 250B, and stores the output data in the predictions 265A.

As illustrated, the continuous training pipeline 245 includes a feature store 260B, a copy or instance of the model 250C, and a predictions store 265B. For example, the application(s) 270C may provide input data, to be processed in real-time or in batches, which can be optionally stored in the features 260B. The continuous training pipeline 245 can then process this data using the model 250C to generate predictions 265B, which are returned to the requesting application 270C. In the illustrated example, the applications 270C may optionally store labeled exemplars (e.g., newly-labeled data) in the features 260B or in other repositories to enable the continuous training. In some aspects, when appropriate triggering criteria are met (e.g., defined in the configuration), the continuous training pipeline 240 retrieves the new labeled training data, and uses it to refine or update the model 250C. In some aspects, as discussed above, the refined model can then be stored in the model registry 220, which may trigger automatic creation of another inferencing pipeline for the refined model.

### Example Workflow for Self-Serve Model Deployment

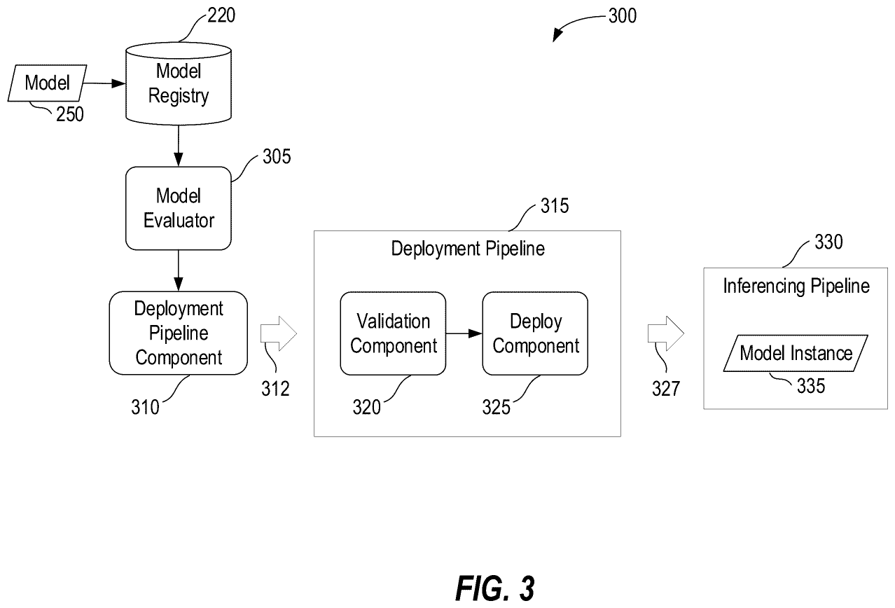

FIG. 3 depicts an example workflow 300 for self-serve machine learning model deployment. For example, the workflow 300 may be used to instantiate real-time and/or batch inferencing pipelines. In some embodiments, the workflow 300 is performed by a machine learning system, such as the machine learning system 115 of FIG. 1.

In the illustrated example, a model 250 is provided to a model registry 220. For example, as discussed above, a user (e.g., a data scientist) may provide a request or submission including the model 250, and requesting that it be instantiated for inferencing. In some embodiments, as discussed above, the model 250 corresponds to a model definition, and specifies relevant data or information for the model, such as its design and/or architecture, hyperparameters, and the like.

Although not included in the illustrated example, in some aspects, the model 250 also includes (or is associated with) one or more configuration files indicating how the model should be instantiated. For example, the configuration may indicate whether the model 250 is ready for deployment, whether it should be deployed for batch inferencing or real-time inferencing, what specific input data is used, what preprocessing should be applied to input data, and the like.

In the illustrated workflow 300, a model evaluator 305 can monitor the model registry 220 to enable automated deployment of machine learning models. For example, the model evaluator 305 may identify new models stored in the model registry 220, periodically scan the registry, and the like. In some aspects, the model evaluator 305 can identify any models with a deployment flag indicating that they are ready for deployment. For example, as discussed above, the user (or another system) may add a model 250 to the model registry 220 with a deploy label or flag, or may set the deploy label or flag of a model 250 already stored in the registry 220.

In some aspects, the model evaluator 305 can additionally or alternatively evaluate other criteria prior to deployment, such as whether the model group, to which the model 250 belongs, exists and has the proper label (e.g., whether the group to which the model belongs also has a “deploy” flag set to true), whether the model is approved/registered (in addition to having a “deploy” label), whether the model 250 has a proper link to the configuration file, and the like.

In the depicted example, if the model evaluator 305 determines that the relevant criteria are satisfied such that the model 250 is ready for deployment, the deployment pipeline component 310 is triggered to begin the process of the deployment. In some aspects, the deployment pipeline component 310 can similarly perform a number of evaluations, such as to determine whether a deployment pipeline already exists for the model 250. In some embodiments, for a given model 250, the system can use a single model deployment pipeline to deploy multiple instances of the model. For example, the same pipeline may be used to deploy the model as a real-time inferencing endpoint, as well as a batch inference endpoint.

In at least one embodiment, the deployment pipeline can similarly be re-used across multiple versions of the same model. For example, in one such embodiment, different versions of the model 250 (e.g., having different weights, such as after a re-training or refinement operation) may be deployed by the same deployment pipeline if the architecture remains the same (e.g., if the new version of the mode uses the same input data, same preprocessing, and the like).

In the illustrated example, therefore, the deployment pipeline component 310 can first determine whether a deployment pipeline already exists for the indicated model definition. If so, the deployment pipeline component 310 can refrain from instantiating a new deployment pipeline, and instead use the existing deployment pipeline to deploy the model. If no such pipeline exists, in the illustrated example, the deployment pipeline component 310 can instantiate one (as indicated by arrow 312).

In some embodiments, in addition to or instead of checking whether a deployment pipeline already exists, the deployment pipeline component 310 can evaluate a variety of other criteria prior to proceeding. For example, the deployment pipeline component 310 may confirm whether the required tags exist in the model's configuration file (e.g., whether there is a tag indicating “batch inference” or “real-time inference,” whether the deploy tag is set to true, and the like).

As discussed above, instantiating the deployment pipeline may generally include instantiating, creating, deploying, or starting a set of components or other processes (e.g., software modules) to perform the sequence of operations needed to deploy the model 250. For example, the deployment pipeline component 310 may create a deployment pipeline 315 that includes a validation component 320 and/or a deploy component 325. Although two discrete components are depicted within the deployment pipeline 315 for conceptual clarity, in some aspects, the operations of each may be combined or distributed across any number of components.

Further, other components or operations not depicted in the illustrated example may be included. For example, in at least one embodiment, the system may use one or more state change rules to monitor the model registry 220, updating the deployment pipeline 315 accordingly. For example, if the state or status of the model and/or model group changes from “approved” to “pending” or “declined” and/or if the model deployment flag changes from “true” to “false,” the system may automatically undeploy the model (e.g., by deleting it from production accounts, deleting the deployment pipeline, and the like). It can then be redeployed using the workflow 300 if the state changes, as discussed above.

In some embodiments, instantiating the deployment pipeline 315 is performed based at least in part on the configuration associated with the model 250. That is, different operations or processes may be used to deploy the model depending on whether preprocessing is to be performed on the input data, what preprocessing is used, whether the mode is deployed as real-time or batch inference, and the like.

The deployment pipeline 315 is generally used to deploy an inferencing pipeline that uses the indicated model 250 to generate inferences or predictions. The validation component 320 may generally be used to validate and/or perform integration tests for the model 250. For example, the validation component 320 may be used to confirm that the model 250 operates deterministically. Some models may perform non-deterministically (e.g., with some degree of randomness) in their predictions, which may be undesirable for the system. In some aspects, therefore, the validation component 320 can process input data (e.g., sample data included with the model 250 in the registry) multiple times in order to confirm that the output prediction is the same. That is, the validation component 320 may process a test exemplar more than one time, comparing the generated outputs to determine whether they match. If so, the validation component 320 may confirm that the model is behaving deterministically, and can proceed with deployment. In an embodiment, if the mode is not deterministic, the validation component 320 can refrain from further processing (e.g., preventing the model from being deployed).

As another validation example, the validation component 320 may confirm that malformed or otherwise inappropriate input data results in an appropriate error or other output. That is, the validation component 320 may use a test exemplar that does not satisfy one or more criteria specified in the configuration of the model (e.g., in the registry), and process this data using the model. For example, the criteria may specify the proper length of the input data (e.g., the number of dimensions in a vector), the specific features to be used as input, and the like. In an embodiment, this text data may fail one or more of these criteria. Rather than generating faulty output (e.g., an unreliable prediction), in an embodiment, the validation component 320 can confirm that the model returns an error or otherwise does not produce an output inference.

As another validation example, the validation component 320 may confirm that the model is operating correctly based on test data indicated in the configuration. For example, the validation component 320 may process valid input (e.g., supplied or indicated by a user) to generate an output inference, and confirm that the output inference is valid (e.g., that the output is itself a valid inference, and/or that the output matches the proper or correct output for the test data, as indicated in the configuration data).

In at least one embodiment, the validation component 320 can determine which test(s) to perform based at least in part on the configuration associated with the model 250. For example, the configuration may specify which test(s) to perform, or the validation component 320 may determine which test(s) are relevant based on the specific architecture or design of the model (e.g., based on what input data it uses, how that input data is formatted, and the like).

In an embodiment, if the validation component 320 determines that any aspect of the validation and integration failed, it can stop the deployment pipeline 315. That is, the deployment pipeline 315 may refrain from any further processing, and refrain from instantiating or deploying the model inferencing pipeline. In some embodiments, the validation component 320 and/or deployment pipeline 315 can additionally or alternatively generate and provide an alert or other notification (e.g., to the user associated with the model 250, such as the data scientist or other user that designed it, or the user that provided the request/submission to deploy it). In an embodiment, this notification may indicate which validation test(s) failed, what the next steps should be (e.g., how to remedy them), and the like.

In the illustrated example, if the validation component 320 confirms that the relevant tests succeeded and the model was validated, the deploy component 325 can be triggered to instantiate and/or deploy the inferencing pipeline 330, as indicated by arrow 327.

In some embodiments, as discussed above, deploying the inferencing pipeline 330 can generally include instantiating, creating, deploying, or starting a set of components or other processes (e.g., software modules) to perform inferencing using the model 250. For example, the deployment component 325 may determine (e.g., based on the configuration included with the model and/or submission or request) whether the model 250 is being deployed for batch inference or real-time inference, and proceed accordingly (e.g., instantiating the proper systems or components for each).

In the illustrated example, the deployment component 325 creates the inferencing pipeline 330, which includes a model instance 335 corresponding to the model 250. That is, the model instance 335 may be a copy of the model 250. As discussed above, the deployment pipeline 315 may create multiple inferencing pipelines 330, each with a corresponding model instance 335, for inferencing. In some embodiments, instantiating the inferencing pipeline 330 can include starting or triggering an endpoint (e.g., a virtual machine or a container) to host the model instance 335.

Although not included in the illustrated example, in some embodiments, the inferencing pipeline 330 can optionally include other components, such as a feature pipeline. That is, the deploy component 325 may retrieve or determine transformations or other preprocessing that should be applied to input data (e.g., based on the configuration file of the model 250, in the model registry 220), and use this information to create a feature pipeline (e.g., a sequence of components or processes) to perform the indicated operations within the inferencing pipeline 330. In at least one embodiment, the configuration specifies the feature pipeline itself, or otherwise points to or indicates the specific transformations or other operations that are applied to input data.

In some embodiments, as discussed above, the inferencing pipeline 330 may additionally or alternatively include other components, such as APIs (e.g., APIs 255 of FIG. 2) that enable connectivity between the model instance 335 and applications that use the inferencing pipeline 330, data stores (or pointers to data stores) where input and/or output data is stored, and the like.

The inferencing pipeline 330 (or a pointer thereto) can then be returned or provided to the entity that requested the deployment or provided the submission. For example, a pointer or link to the inferencing pipeline 330 may be returned, allowing the user or other entity to begin using the inferencing pipeline 330.

In this way, aspects of the present disclosure can enable the automated deployment of trained machine learning models in a self-serve manner, reducing or eliminating the need for manual configuration and instantiation of the needed components and systems that is required by conventional approaches. This allows models to be deployed more rapidly, more accurately, and more reliably than conventional approaches.

### Example Workflow for Continuous Learning Pipeline Deployment

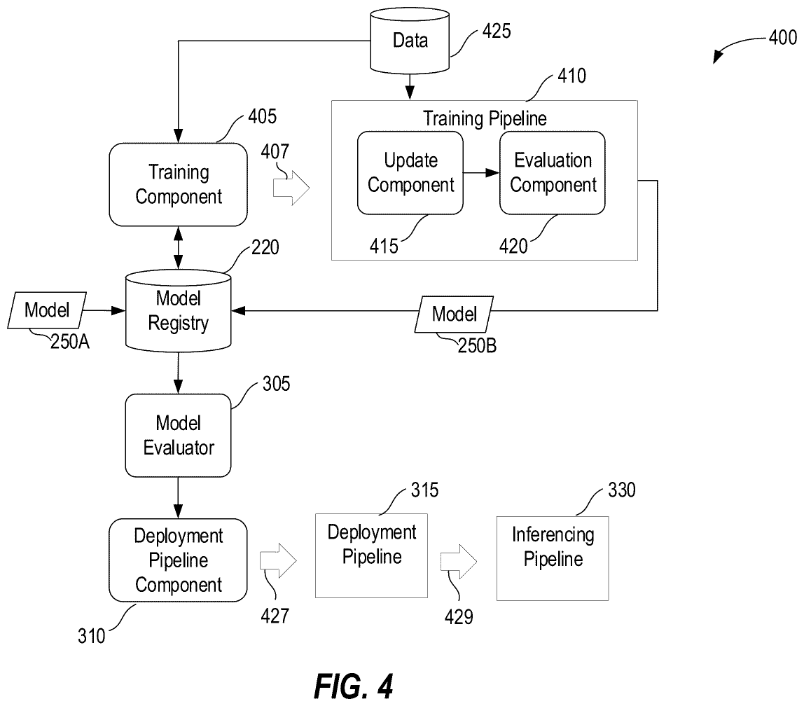

FIG. 4 depicts an example workflow 400 for automated continuous learning pipeline deployment. For example, the workflow 400 may be used to instantiate training pipelines. In some embodiments, the workflow 400 is performed by a machine learning system, such as the machine learning system 115 of FIG. 1.

In the illustrated example, a model 250A can be provided to the model registry 220, as discussed above. For example, a user may submit the model 250A, along with a corresponding configuration, to the model registry 220 and request that the model be trained and/or deployed for continuous learning. In some embodiments, the model 250A may be an untrained model (e.g., a model definition specifying the architecture and hyperparameters, but without trained weights or other learnable parameters, or with random values for these parameters). In other embodiments, the model 250A may be a trained model.

In an embodiment, if the model 250A is a trained model, the model evaluator 305 may identify one or more flags indicating that it is ready for deployment, as discussed above. This may generally trigger the deployment process discussed above with reference to FIG. 2, where the model evaluator 305 evaluates various criteria before triggering the deployment pipeline component 310, which similarly evaluates one or more criteria before using an existing deployment pipeline 315 or instantiating a new one (indicated by arrow 427), which in turn performs various evaluations and operations to create the inferencing pipeline 330 for the model 250A (indicated by arrow 429).

The inferencing pipeline 330 can then be used for inferencing, as discussed above. In at least one aspect, before, during, or after this process, a training component 405 can additionally perform a variety of operations to instantiate a training pipeline 410 (as indicated by arrow 407). In some embodiments, the training component 405 may similarly be used if the model 250A has not-yet been trained. That is, the training component 405 may be used to provide initial training of the model.

As illustrated, the training component 405 may monitor the model registry 220 in a similar manner to the model evaluator 305. In one embodiment, the training component 405 can determine whether the model 250A, in the model registry 220, is ready for training. For example, the training component 405 may determine whether a training and/or refinement flag or label are associated with the model (e.g., in its configuration file). When the training component 405 detects such a label, the training component 405 can automatically instantiate a training pipeline 410 (as indicated by arrow 407).

As discussed above, instantiating the training pipeline 410 can generally correspond to instantiating, creating, deploying, or otherwise starting a set of components or other processes (e.g., software modules) to perform the sequence of operations needed to train the model 250A. For example, the training component 405 may create a training pipeline 410 that includes an update component 415 and/or an evaluation component 420. Although two discrete components of the training pipeline 410 are depicted for conceptual clarity, in embodiments, the operations of each may be combined or distributed across any number of components. Similarly, other operations and components beyond those included in the depicted workflow 400 may be used.

In the illustrated example, the update component 415 may generally be used to retrieve training data for the model 250A (e.g., from the data 425) and refine the model (e.g., update one or more learnable parameters) based on the training data. Although depicted as a single repository for conceptual clarity, in some embodiments, the data 425 may be distributed across any number of systems and repositories. For example, the update component 415 may retrieve or receive the input examples from one data store, look up the target output/labels in another, and the like.

In some embodiments, the data 425 is indicated in the configuration of the model and/or the request or submission requesting that the model be trained. That is, the submission and/or configuration may indicate the specific storage locations in the data 425 (e.g., database tables or other repositories) where training data for the model 250A can be found.

In some embodiments, the particular operations used by the training component 415 may vary depending on the particular model architecture. That is, the training component 405 may instantiate different components or processes for the update component 415 depending on the particular architecture (e.g., depending on whether the model 250A is a neural network, a random forest model, and the like). In this way, the system can automatically and dynamically provide training without requiring the user to understand or manually instantiate such components.

As an example, if the model 250A is an artificial neural network, the update component 415 may pass an input training sample through the model to generate an output inference, and compare this inference against a ground-truth label included with the input data (e.g., a classification or numerical value). The difference between the generated output and the actual desired output may be used to define a loss that can be used to update the model parameters (e.g., to update the weights of one or more layers of the mode using backpropagation and gradient descent).

In some aspects, the update component 415 can perform this training or refinement process based on the submission and/or configuration of the model 250A. For example, the update component 415 may determine the training hyperparameters (e.g., learning rates) based on the configuration, may determine whether to use batches of training data (e.g., batch gradient descent) or individual training samples (e.g., stochastic gradient descent), and the like.

In the illustrated example, once training is complete, the trained model is passed to an evaluation component 420. In embodiments, training may be considered “complete” based on a variety of criteria, some or all of which may be specified in the configuration and/or submission of the model 250A. For example, the termination criteria may include using a defined number of exemplars to refine the model, using training data to refine the model until a defined period of time has elapsed, refining the model until a minimum desired model accuracy is reached, refining the model until all of the available exemplars in the data 425 have been used, and the like.

In an embodiment, the evaluation component 420 may optionally perform a variety of evaluations on the updated model. For example, the evaluation component 420 may process test data (e.g., a subset of the training exemplars, indicated for the model, in the data 425) to determine the model accuracy, inference time (e.g., how long it takes to process one test sample using the trained model), and the like. In some aspects, the evaluation component 420 may determine aspects of the model itself, such as its size (e.g., the number of parameters and/or storage space required). Generally, the evaluation component 420 may collect a wide variety of performance metrics for the model. These metrics may be stored with the training data (in the data 425), alongside the updated model in the model registry 220 (e.g., in the configuration file), output to a user (e.g., transmitted or displayed to the user or other entity that initiated the training process), and the like.

In the illustrated workflow 400, the training pipeline 410 outputs the updated model 250B and stores it back in the model registry 220. In some embodiments, the training pipeline 410 can automatically set the deploy flag or label of the model 250B, such that the model evaluator 305 automatically begins the deployment process for it, as discussed above.

Although not included in the illustrated embodiment, in some aspects, once the model is deployed in an inferencing pipeline 330, the training component 405 can monitor one or more triggering criteria to determine when retraining is needed. For example, the training component 405 can use a time-based trigger (e.g., to enable periodic re-training, such as weekly). In some aspects, the training component 405 uses event-based triggers, such as user input or the addition of new training data in the indicated data 425, or monitoring whether the deployed model (in the inferencing pipeline 330) is producing adequate predictions.

For example, users of the inferencing pipeline 330 may use the deployed model to generate output inferences or predictions based on their input data. In some aspects, the participating entities may optionally determine an actual output label for the data subsequently (e.g., where the model provides a prediction for the future, and the actual value can be determined subsequently). Such entities may then optionally create and store new training samples (e.g., in the indicated portions of the data 425), where each new training sample includes input data and a corresponding ground-truth output value or label.

In an embodiment, when the training component 405 determines that one or more triggering criteria are met, it can use the instantiated training pipeline 410 to refine the model further, generating another new model 250. As above, this new model may again be stored in the registry, automatically beginning another deployment process (which may reuse the deployment pipeline 315 that was previously created) to instantiate a new inferencing pipeline 330 including the new model. In some embodiments, as discussed above, the prior inferencing pipeline 330 (with the old model version) may remain deployed. In other embodiments, the system may automatically terminate the prior pipeline(s) in favor of the new one.

In this way, the workflow 400 can iterate indefinitely or until defined criteria are met, continuing to refine and deploy the model over time. This can provide seamless continuous learning, allowing the model to be repeatedly updated for improved accuracy and performance, without requiring any further input or effort from the user or entity that provided the initial submission or request. This is a significant improvement over conventional systems.

### Example Method for Self-Serve Machine Learning Deployment

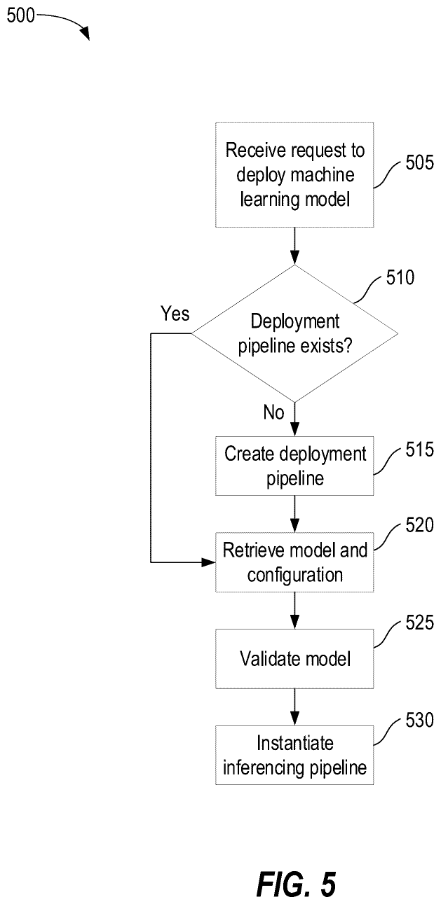

FIG. 5 is a flow diagram depicting an example method 500 for self-serve machine learning deployment. In some embodiments, the method 500 provides additional detail for the workflow 300 of FIG. 3. In some embodiments, the method 500 is performed by a machine learning system, such as the machine learning system 115 of FIG. 1.

At block 505, the machine learning system receives a request to deploy a machine learning model. In some aspects, this request is referred to as a submission of a machine learning model for deployment, as discussed above. For example, as discussed above, the request may specify a model definition, configuration information indicating how the model should be deployed, and the like. In some aspect, receiving the request includes identifying or receiving a model definition in a registry (e.g., model registry 220 of FIG. 2), where the model is associated with a flag or label indicating or requesting deployment. That is, rather than receiving an explicit user request, the machine learning system may identify a model (in the registry) with a deployment tag, where the model and tag may have been generated and/or added to the registry by a user, automatically by another system (e.g., from a training pipeline), and the like.

At block 510, the machine learning system determines whether a deployment pipeline exists for the model definition. That is, as discussed above, the machine learning system may instantiate new a deployment pipeline for a new model, but may re-use a prior-created pipeline for models that have already been deployed (e.g., where the same model was already deployed, or where a different version of the model, such as one with the same model architecture but with different values for the learnable parameters, has been deployed). Although not included in the illustrated example, in some embodiments, the machine learning system may similarly perform other evaluations or checks, such as to confirm that the configuration file is complete and ready for deployment.

If, at block 510, the machine learning system determines that a deployment pipeline for the indicated model definition already exists, the method 500 continues to block 520. If the machine learning system determines that such a pipeline does not exist, the method 500 proceeds to block 515. At block 515, the machine learning system instantiates or creates a deployment pipeline for the indicated model. For example, as discussed above, the machine learning system may create, start, instantiate, or otherwise generate a set of components or processes (e.g., software modules), such as one or more virtual machines, to deploy the model. In some aspects, as discussed above, the machine learning system may create the deployment pipeline based at least in part on the specifics of the indicated model definition. For example, different validation operations may be included in the pipeline, or different components may be used to test the model depending on the particular architecture. The method 500 then continues to block 520.

At block 520, the machine learning system uses the deployment pipeline (which may be newly-generated, or may be re-used from a prior deployment) to retrieve the model definition and configuration indicated in the request. For example, the machine learning system may retrieve, from the model registry, the model definition (e.g., architecture and hyperparameters, input features, and the like) and configuration information (e.g., preprocessing operations, data storage locations, deployment type, and the like) for the model indicated in the request. In some aspects, this includes copying or moving the model definition and configuration from the model repository into a central memory or repository, and/or into a repository or memory of the deployment pipeline.

At block 525, the machine learning system optionally uses the deployment pipeline to validate the model. For example, as discussed above with reference to validation component 320 of FIG. 3, the machine learning system may perform one or more tests (e.g., using test data included in the request, or indicated in the model configuration) to confirm that the model operates deterministically, that the model correctly generates errors for malformed data, that the model generates correct and/or properly formed output for correctly-formed data, and the like. Although not included in the illustrated example, in some aspects, if the validation of the model fails, the machine learning system can stop the deployment process and generate an alert, error, or notification indicating the issue(s).

After validation, the method 500 continues to block 530, where the machine learning system instantiates an inferencing pipeline for the model definition. For example, as discussed above, the machine learning system may instantiate, generate, create, or otherwise start one or more components or modules (e.g., virtual machines) to perform inferencing using the indicated model. In some embodiments, as discussed above, instantiating the inferencing pipeline can include retrieving or accessing a feature pipeline definition (to be used to preprocess data for the model), and using this definition to instantiate or create a set of operations used to preprocess the data before inferencing.

As discussed above, this inferencing process can include steps such as receiving or accessing input, formatting or preprocessing it, passing it through the model to generate an output inference, and/or returning or storing the generated output.

Advantageously, using the method 500, the machine learning system is able to automatically perform the needed validations and tests, using dynamically-generated pipelines and systems, to deploy machine learning models. In doing so, the machine learning system enables more rapid model deployment and prototyping, as well as more diverse and varied use of machine learning models in a wider array of deployments and implementations.

### Example Method for Automated Real-Time Inferencing

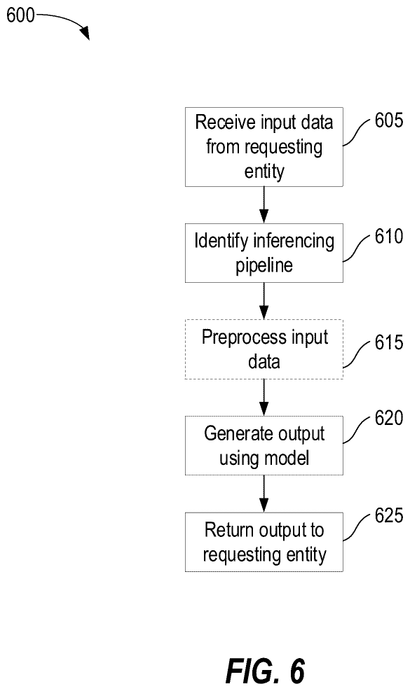

FIG. 6 is a flow diagram depicting an example method 600 for real-time inferencing using automatically deployed models. In some embodiments, the method 600 is performed using an instantiated inferencing pipeline (e.g., created at block 530 of FIG. 5). In some embodiments, the method 600 is performed by a machine learning system, such as the machine learning system 115 of FIG. 1.

At block 605, the machine learning system receives or accesses input data from a requesting entity. For example, using an API (e.g., API 255 of FIG. 2), the requesting entity (which may be an automated application, a user-controlled application, and the like) can provide data to be used as input to the model in order to generate an output inference. Generally, the formatting and content of the input may vary substantially depending on the particular model and implementation. For example, in an image classification embodiment, the input may include one or more images. In a weather prediction embodiment, the input may include time series data relating to weather.

At block 610, the machine learning system identifies the corresponding inference pipeline for the input data. In some aspects, the input is provided, by the requesting entity, directly to the corresponding inference pipeline (e.g., using the corresponding API). In other embodiments, the input request may indicate the model to be used, and the machine learning system can identify the appropriate pipeline (e.g., identifying the inferencing pipeline that uses the most-recently trained or refined version of the indicated model).

At block 615, the machine learning system can optionally use the inferencing pipeline to preprocess the input data. For example, as discussed above, the inferencing pipeline may include a feature pipeline or component that uses one or more transformations, operations, or other processes to prepare the input data for processing using the machine learning model. Generally, these preprocessing steps can vary depending on the particular implementation and configuration of the model. For example, the designer of the model may specify that normalization should be used, that the input should be converted to a vector encoding, and the like.

At block 620, the machine learning system uses the inferencing pipeline to generate an output inference by processing the input data (or the prepared/preprocessed input data) using the deployed model. As discussed above, the actual operations for processing data using the model may vary depending on the particular model architecture. Similarly, the format and content of the output inference may vary depending on the particular implementation or model. For example, the output inference may include a classification of the input data, a numerical value for the data (e.g., generated using a regression model), and the like. In some aspects, the output can further include a confidence score or other value, generated by the model. This confidence score can indicate, for example, the probability or likelihood that the output inference is accurate (e.g., the probability that the input data belongs to the generated category).

At block 625, the machine learning system then returns the generated output to the requesting entity (e.g., via the API). In this way, the method 600 enables automatically-generated inferencing pipelines to automatically receive and process input data to return generated outputs. This significantly reduces complexity in the machine learning process, reducing error and generally improving the operations of the machine learning system (as well as the operations of the requesting entity relying on such predictions).

### Example Method for Automated Batch Inferencing

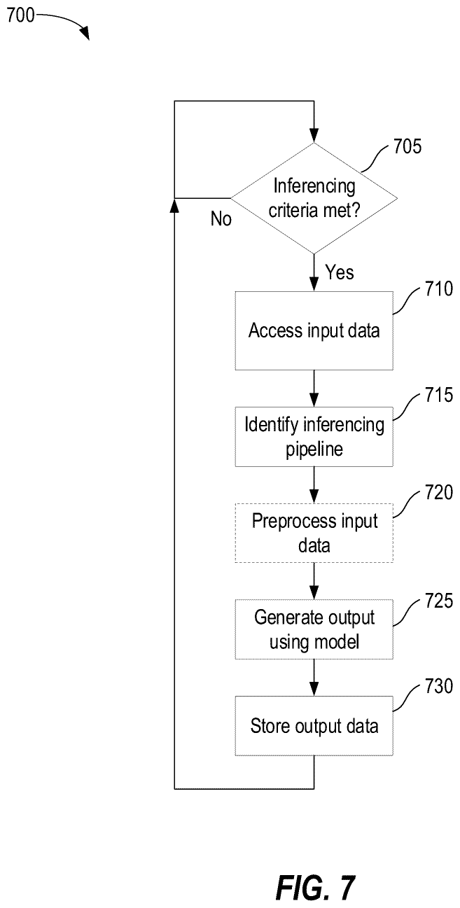

FIG. 7 is a flow diagram depicting an example method 700 for batch inferencing using automatically deployed models. In some embodiments, the method 700 is performed using an instantiated inferencing pipeline (e.g., created at block 530 of FIG. 5). In some embodiments, the method 700 is performed by a machine learning system, such as the machine learning system 115 of FIG. 1.

At block 705, the machine learning system determines whether one or more inferencing criteria are met. In some aspects, the inferencing criteria are specified in the configuration or request used to instantiate the inferencing pipeline. For example, the criteria may specify that the machine learning system should process the batch of data periodically (e.g., processing any stored data hourly), upon certain events or occurrences (e.g., when the number of input samples meets or exceeds a minimum number of samples), and the like. If the machine learning system determines that the inference criteria are not satisfied, the method 700 iterates at block 705.

If the machine learning system determines that the inferencing criteria are met, the method 700 continues to block 710. At block 710, the machine learning system receives or accesses input data (from one or more requesting entities) for the batch inference process. For example, as discussed above, requesting entities (which may be automated applications, user-controlled applications, and the like) can provide data, to be used as input to the model, to a repository or storage location (e.g., a database table). When the inferencing criteria are met, the machine learning system can retrieve or access these stored samples for processing (e.g., retrieving them from the designated storage repository or location).

At block 715, the machine learning system identifies the corresponding inference pipeline for the input data. As discussed above, in some aspects, the input is provided, by the requesting entity, directly to the corresponding inference pipeline (e.g., using the corresponding API). In other embodiments, the input request may indicate the model to be used, and the machine learning system can identify the appropriate pipeline (e.g., identifying the inferencing pipeline that uses the most-recently trained or refined version of the indicated model).

At block 720, the machine learning system can optionally use the inferencing pipeline to preprocess the input data. For example, as discussed above, the inferencing pipeline may include a feature pipeline or component that uses one or more transformations, operations, or other processes to prepare the input data for processing using the machine learning model. Generally, these preprocessing steps can vary depending on the particular implementation and configuration of the model. For example, the designer of the model may specify that normalization should be used, that the input should be converted to a vector encoding, and the like. In some aspects, the machine learning system can process the input data sequentially (e.g., processing one sample at a time). In at least one aspect, the machine learning system processes some or all of the input samples in parallel (e.g., using one or more feature pipelines).

At block 725, the machine learning system uses the inferencing pipeline to generate output inference(s) by processing the input data sample(s) (or the prepared/preprocessed input data) using the deployed model. As discussed above, the actual operations for processing data using the model may vary depending on the particular model architecture. Similarly, the format and content of the output inference may vary depending on the particular implementation or model. For example, the output inference for a given data sample may include a classification of the input sample, a numerical value for the sample (e.g., generated using a regression model), and the like. In some aspects, the output can further include, for each output inference/input data sample, a corresponding confidence score or other value, generated by the model. This confidence score can indicate, for example, the probability or likelihood that a given output inference is accurate (e.g., the probability that the corresponding input data belongs to the generated category).

At block 730, the machine learning system then stores the generated output data in a designated location or repository (e.g., the same database table where the input data was accessed from, or a different database table). The method 700 then returns to block 705, to begin the process again.

In this way, the method 700 enables automatically-generated inferencing pipelines to automatically receive and process input data in batches in order to generate output inferences. This significantly reduces complexity in the machine learning process, reducing error and generally improving the operations of the machine learning system (as well as the operations of the requesting entity relying on such predictions).

### Example Method for Automated Continuous Learning

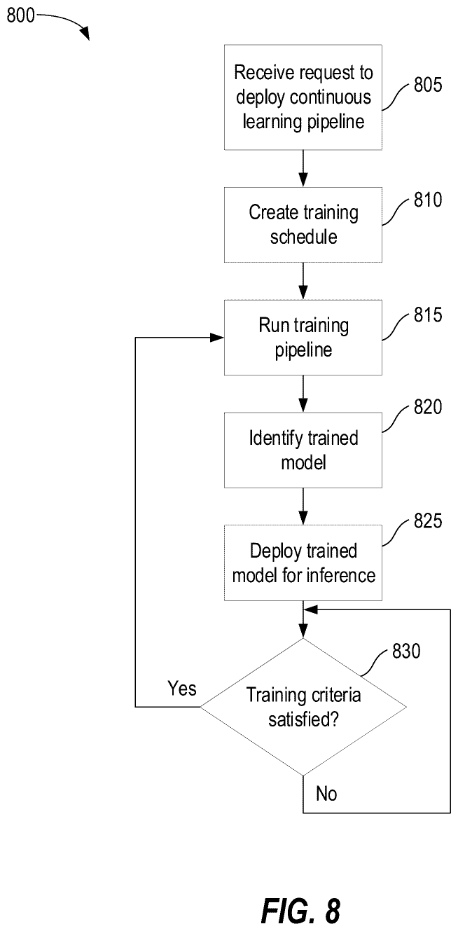

FIG. 8 is a flow diagram depicting an example method 800 for automated continuous learning deployment. In some embodiments, the method 800 provides additional detail for the workflow 400 of FIG. 4. In some embodiments, the method 800 is performed by a machine learning system, such as the machine learning system 115 of FIG. 1.

At block 805, the machine learning system receives a request to deploy a continuous learning pipeline for a model definition. In some aspects, this request is referred to as a submission of a machine learning model for training or refinement, as discussed above. For example, as discussed above, the request may specify a model definition, configuration information indicating how the model should be deployed, training configurations such as where training data is stored and re-training criteria, and the like. In some aspect, receiving the request includes identifying or receiving a model definition in a registry (e.g., model registry 220 of FIG. 4), where the model is associated with a flag or label indicating or requesting deployment with continuous learning. That is, rather than receiving an explicit user request, the machine learning system may identify a model (in the registry) with a training/continuous learning tag, where the model and tag may have been generated and/or added to the registry by a user, automatically by another system (e.g., from a training pipeline), and the like.

At block 810, the machine learning system creates a training schedule based on the request. For example, as discussed above, the machine learning system may create one or more event listeners (e.g., to monitor whether new training data has been added to a storage repository), one or more timers (e.g., to determine whether an indicated period has elapsed), and the like. Generally, the training schedule may be used to control when and how the model is trained or updated. In at least one embodiment, the training schedule is implemented by the training component 405 of FIG. 4.

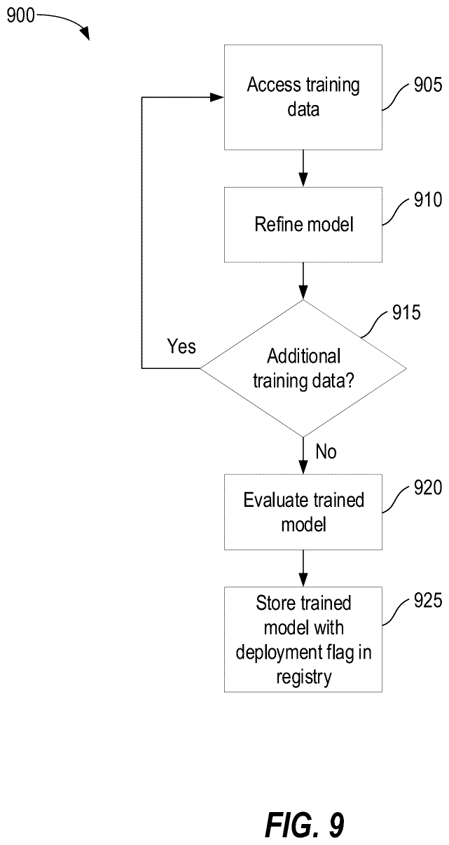

At block 815, the machine learning system can instantiate and/or run a training pipeline (e.g., training pipeline 410) to train or update the model, as discussed above. In some embodiments, rather than immediately running the training pipeline to train the model, the machine learning system may first deploy the current version of the model for inferencing, as discussed above. In embodiments, the training pipeline is generally used to generate a new version of the model. For example, as discussed above, the training pipeline may receive, retrieve, or otherwise access training data (e.g., from a designated repository or location indicated in the request and/or configuration file) and use the data to update the model parameters. In some embodiments, the machine learning system can then store the newly-updated model in the model registry, along with a flag indicating that it is ready for deployment for inferencing. One example method for running the training pipeline is discussed in more detail below with reference to FIG. 9.

At block 820, the machine learning system identifies or detects the presence of the newly-trained model in the model registry. For example, as discussed above, the machine learning system (e.g., a model evaluator 305 of FIG. 3) may detect or identify the presence or addition of the newly-trained model in the registry (e.g., based on the deployment flag). In response, at block 825, the machine learning system deploys the newly-trained model for inferencing. In some aspects, this deployment process may be performed using the method 500 of FIG. 5.

At block 830, the machine learning system determines whether one or more training criteria (also referred to as update criteria, retraining criteria, refinement criteria, and the like) are satisfied. For example, the machine learning system can use the training schedule (e.g., event listener(s) and/or timer(s)) to determine whether the model should be re-trained or updated as part of the continuous learning deployment. As discussed above, this training criteria can include a wide variety of considerations, such as periodic retraining, retraining based on event occurrences, and the like.

If, at block 830, the machine learning system determines that the training criteria is not met, the method 800 iterates at block 830. If the training criteria is met, the method 800 returns to block 815 to run the training pipeline again using (new) training data. In this way, the machine learning system can iteratively update the model using new data, thereby ensuring that it remains continuously updated and maximizing the model accuracy and reliability.

Advantageously, using the method 800, the machine learning system is able to automatically perform the needed training, validations and tests, and deployment using dynamically-generated pipelines and systems, to train, refine, monitor, and deploy machine learning models. In doing so, the machine learning system enables more rapid model training and deployment, as well as more diverse and varied use of machine learning models in a wider array of deployments and implementations.

### Example Method for Model Training using Training Pipelines

FIG. 9 is a flow diagram depicting an example method 900 for automatically training machine learning models using deployed pipelines. In some embodiments, the method 900 provides additional detail for block 815 of FIG. 8). In some embodiments, the method 900 is performed by a machine learning system, such as the machine learning system 115 of FIG. 1.

At block 905, the machine learning system accesses training data for the model. For example, as discussed above, the model configuration may specify one or more storage locations or repositories (e.g., a database table or other data structure) where the training data is stored. In some aspects, as discussed above, the training data is stored in a single data repository (e.g., with input data and corresponding output labels in a single store). In other aspects, the data may be distributed (e.g., with input data stored in one or more different locations, and corresponding output labels in one or more other locations). In some embodiments, accessing the training includes retrieving or accessing each training exemplar independently (e.g., using each to separately refine the model). In other aspects, the machine learning system can access multiple samples (e.g., to perform batch training).

At block 910, the machine learning system refines the machine learning model based on the training data. As discussed above, this refinement process generally includes updating one or more parameters of the model (such as weights in a neural network) to better fit the training data. During this refinement process, the model learns to make more accurate and reliable predictions for input data during runtime.

At block 915, the machine learning system determines whether there is at least one training exemplar remaining in the indicated repository. If so, the method 900 returns to block 905. If not, the method 900 continues to block 920, where the machine learning system can optionally evaluate the newly-trained or refined model.

For example, as discussed above, the machine learning system may retrieve or access test data (e.g., from the designated repository), process it using the model to generate an output inference, and compare the generated output with a corresponding label or ground-truth for the test sample. In this way, the machine learning system can determine performance metrics such as the model accuracy and reliability.

At block 925, the machine learning system stores the newly-trained model in the model registry, along with a deployment flag or label indicating that it is prepared and ready for deployment. In some aspects, as discussed above, this allows the machine learning system (e.g., via the model evaluator 305 of FIG. 3) to automatically detect the model and begin the deployment process. In some aspects, as discussed above, the performance metrics (determined at block 920) can also be stored along with the model, allowing users to review the model's performance at any given point (e.g., for a given version) and changes over time (e.g., across versions).

### Example Method for Automated Model Deployment

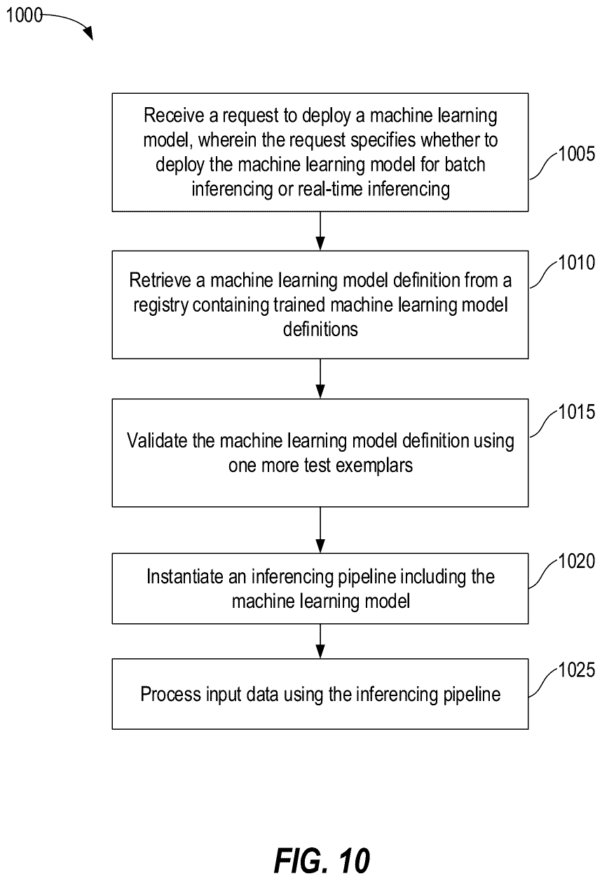

FIG. 10 is a flow diagram depicting an example method 1000 for automatically deploying machine learning models. In some embodiments, the method 1000 provides additional detail for the workflow 300 of FIG. 3 and/or the method 500 of FIG. 5. In some embodiments, the method 1000 is performed by a machine learning system, such as the machine learning system 115 of FIG. 1.

At block 1005, a request to deploy a machine learning model (e.g., model 250 of FIG. 3) is received, wherein the request specifies whether to deploy the machine learning model for batch inferencing or real-time inferencing.

At block 1010, a machine learning model definition is retrieved from a registry (e.g., model registry 220 of FIG. 2) containing trained machine learning model definitions.

At block 1015, the machine learning model definition is validated using one more test exemplars (e.g., by validation component 320 of FIG. 3).

At block 1020, an inferencing pipeline (e.g., inferencing pipeline 330 of FIG. 3) including the machine learning model is instantiated.

In some aspects, the operations of blocks 1010, 1015, and 1020 may collectively be referred to as instantiating a deployment pipeline for the machine learning model. In some aspects, blocks 1010, 1015, and 1020 may be performed in response to determining that a deployment pipeline for the machine learning model is not available.

At block 1025, input data is processed using the inferencing pipeline.

### Example Method for Automated Model Training

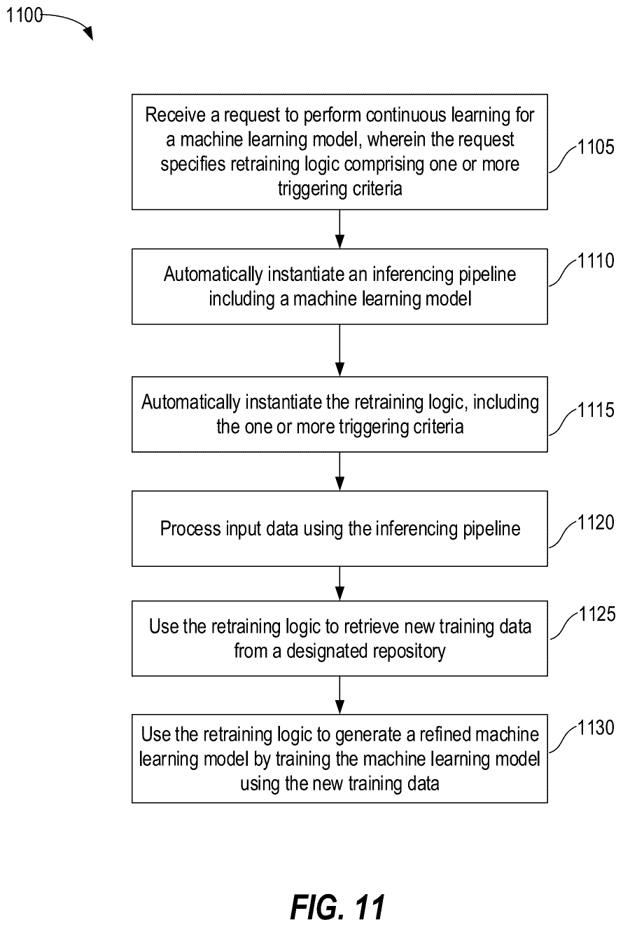

FIG. 11 is a flow diagram depicting an example method 1100 for automatically performing continuous learning of machine learning models. In some embodiments, the method 1100 provides additional detail for the workflow 400 of FIG. 4 and/or the method 800 of FIG. 8. In some embodiments, the method 1100 is performed by a machine learning system, such as the machine learning system 115 of FIG. 1.

At block 1105, a request to perform continuous learning for a machine learning model (e.g., model 250A of FIG. 4) is received, wherein the request specifies retraining logic comprising one or more triggering criteria.

At block 1110, an inferencing pipeline (e.g., inferencing pipeline 330 of FIG. 4) including the machine learning model is automatically instantiated.

At block 1115, the retraining logic, including the one or more triggering criteria, is automatically instantiated (e.g., by training component 405 of FIG. 4).

At block 1120, input data is processed using the inferencing pipeline.

At block 1125, the retraining logic is used to retrieve new training data from a designated repository (e.g., data 425 of FIG. 4).

At block 1130, the retraining logic is used to generate a refined machine learning model (e.g., model 250B of FIG. 4) by training the machine learning model using the new training data.

In some aspects, the operations of blocks 1125 and 1130 may be performed automatically in response to determining that the one or more triggering criteria are satisfied.

### Example Computing Device for Automated Model Deployment and/or Training

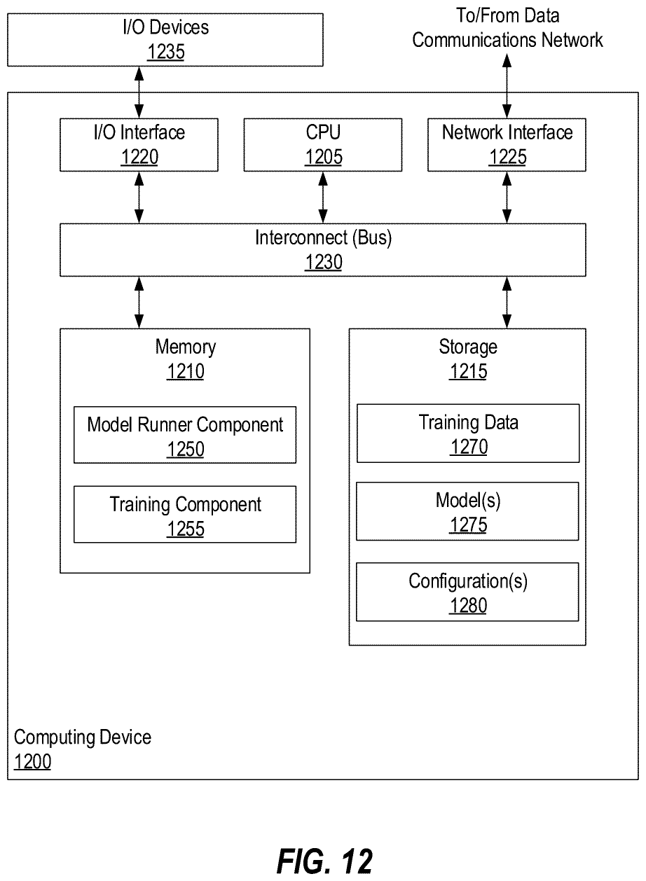

FIG. 12 depicts an example computing device configured to perform various aspects of the present disclosure. Although depicted as a physical device, in embodiments, the computing device 1200 may be implemented using virtual device(s), and/or across a number of devices (e.g., in a cloud environment). In one embodiment, the computing device 1200 corresponds to one or more systems in a healthcare platform, such as a machine learning system (e.g., machine learning system 115 of FIG. 1).

As illustrated, the computing device 1200 includes a CPU 1205, memory 1210, storage 1215, a network interface 1225, and one or more I/O interfaces 1220. In the illustrated embodiment, the CPU 1205 retrieves and executes programming instructions stored in memory 1210, as well as stores and retrieves application data residing in storage 1215. The CPU 1205 is generally representative of a single CPU and/or GPU, multiple CPUs and/or GPUs, a single CPU and/or GPU having multiple processing cores, and the like. The memory 1210 is generally included to be representative of a random access memory. Storage 1215 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 1235 (such as keyboards, monitors, etc.) are connected via the I/O interface(s) 1220. Further, via the network interface 1225, the computing device 1200 can be communicatively coupled with one or more other devices and components (e.g., via a network, which may include the Internet, local network(s), and the like). As illustrated, the CPU 1205, memory 1210, storage 1215, network interface(s) 1225, and I/O interface(s) 1220 are communicatively coupled by one or more buses 1230.

In the illustrated embodiment, the memory 1210 includes a model runner component 1250 and a training component 1255, which may perform one or more embodiments discussed above. Although depicted as discrete components for conceptual clarity, in embodiments, the operations of the depicted components (and others not illustrated) may be combined or distributed across any number of components. Further, although depicted as software residing in memory 1210, in embodiments, the operations of the depicted components (and others not illustrated) may be implemented using hardware, software, or a combination of hardware and software.

In one embodiment, the model runner component 1250 may be used to automatically deploy machine learning models, as discussed above. For example, the model runner component 1250 (which may correspond to the model evaluator 305 and/or deployment pipeline component 310, each of FIG. 3) may monitor a model registry to identify models ready for deployment, and/or receive requests or submissions to deploy models. In response, the model runner component 1250 may automatically deploy the models, such as by creating a deployment pipeline (if one does not exist), using the deployment pipeline to validate and deploy the model in an inferencing pipeline, and the like.

In one embodiment, the training component 1255 may be used to automatically train or refine machine learning models, as discussed above. For example, the training component 1255 (which may correspond to the training component 405 of FIG. 4) may receive training requests or submissions (or identify models, in a registry, that are ready for training), and automatically instantiate and use training pipelines to train the models, deploy them, and/or retrain them when appropriate.

In the illustrated example, the storage 1215 includes training data 1270, one or more machine learning model(s) 1275, and one or more corresponding configuration(s) 1280. In one embodiment, the training data 1270 (which may correspond to data 425 of FIG. 4) may include any data used to train, refine, or test machine learning models, as discussed above. The models 1275 may correspond to model definitions stored in a model registry (e.g., model registry 220 of FIGS. 2, 3, and/or 4), as discussed above. The configurations 1280 generally correspond to the configuration or information associated with models, such as how each model 1275 should be deployed, whether each model is ready for deployment, how training should be performed, and the like, as discussed above. Although depicted as residing in storage 1215 for conceptual clarity, the training data 1270, models 1275, and configurations 1280 may be stored in any suitable location, including memory 1210 or in one or more remote systems distinct from the computing device 1200.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications or systems (e.g., machine learning system 115 of FIG. 1) or related data available in the cloud. For example, the machine learning system could execute on a computing system in the cloud and automatically train, deploy, and/or monitor machine learning models based on user requests or submissions. In such a case, the machine learning system could maintain the model registry and/or processing pipelines in the cloud. Doing so allows a user to access this information from any computing system attached to a network connected to the cloud (e.g., the Internet).

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

### EXAMPLE CLAUSES

Implementation examples are described in the following numbered clauses:

Clause 1: A method, comprising: receiving a request to deploy a machine learning model, wherein the request specifies whether to deploy the machine learning model for batch inferencing or real-time inferencing; in response to determining that a deployment pipeline for the machine learning model is not available, instantiating a deployment pipeline for the machine learning model, comprising: retrieving a machine learning model definition from a registry containing trained machine learning model definitions; validating the machine learning model definition using one more test exemplars; and instantiating an inferencing pipeline including the machine learning model; and processing input data using the inferencing pipeline.

Clause 2: The method of Clause 1, wherein: retrieving the machine learning model from the registry further comprises retrieving a feature pipeline definition for the machine learning model from the registry, the feature pipeline definition indicating how to preprocess input data for the machine learning model, and instantiating the inferencing pipeline comprises generating a feature pipeline based on the feature pipeline definition.

Clause 3: The method of any one of Clauses 1-2, wherein the request specifies to deploy the machine learning model for real-time inferencing, and the method further comprises: receiving input data from a requesting entity; generating prepared data by processing the input data using the feature pipeline; generating an output inference by processing the prepared data using the machine learning model; and providing the output inference to the requesting entity.

Clause 4: The method of any one of Clauses 1-3, wherein: the request specifies to deploy the machine learning model for batch inferencing, and the request further specifies a storage location for the batch inferencing.

Clause 5: The method of any one of Clauses 1-4, the method further comprising: receiving input data from a requesting entity; storing the input data at the specified storage location; and in response to determining that one or more inferencing criteria are satisfied: retrieving the input data from the specified storage location; generating prepared data by processing the input data using the feature pipeline; generating an output inference by processing the prepared data using the machine learning model; and storing the output inference at the specified storage location.

Clause 6: The method of any one of Clauses 1-5, further comprising: receiving a second request to deploy the machine learning model; and in response to determining that the deployment pipeline for the machine learning model is available: refraining from instantiating a new deployment pipeline for the machine learning model based on the second request; and instantiating a new inferencing pipeline, including a second instance of the machine learning model, using the deployment pipeline.

Clause 7: The method of any one of Clauses 1-6, wherein validating the machine learning model definition comprises: generating first output data by processing a first test exemplar using the machine learning model; generating second output data by processing the first test exemplar using the machine learning model; and verifying that the first output data matches the second output data.

Clause 8: The method of any one of Clauses 1-7, wherein validating the machine learning model definition comprises: processing a first test exemplar using the machine learning model, wherein the first test exemplar does not satisfy one or more model criteria specified in the registry; and verifying that the inferencing pipeline returns an error for the first test exemplar.

Clause 9: The method of any one of Clauses 1-8, further comprising: receiving a plurality of machine learning model definitions; receiving a plurality of configuration files for the plurality of machine learning model definitions; and storing the plurality of machine learning model definitions and plurality of configuration files in the registry.

Clause 10: A method, comprising: receiving a request to perform continuous learning for a machine learning model, wherein the request specifies retraining logic comprising one or more triggering criteria; automatically instantiating an inferencing pipeline including the machine learning model; automatically instantiating the retraining logic, including the one or more triggering criteria; processing input data using the inferencing pipeline; and in response to determining that the one or more triggering criteria are satisfied, automatically: using the retraining logic to retrieve new training data from a designated repository; and using the retraining logic to generate a refined machine learning model by training the machine learning model using the new training data.

Clause 11: The method of Clause 10, further comprising: storing the refined machine learning model in a registry containing trained machine learning models; and storing an indication that the refined machine learning model is ready for deployment.

Clause 12: The method of any one of Clauses 10-11, further comprising: automatically instantiating a new inferencing pipeline including the refined machine learning model; and processing new input data using the new inferencing pipeline including the refined machine learning model.

Clause 13: The method of any one of Clauses 10-12, wherein automatically instantiating the new inferencing pipeline including the refined machine learning model comprises retrieving the refined machine learning model from the registry.

Clause 14: The method of any one of Clauses 10-13, further comprising: generating performance metrics by evaluating the refined machine learning model using test data; and storing the performance metrics in the registry.

Clause 15: The method of any one of Clauses 10-14, wherein the designated repository is indicated in the request.

Clause 16: The method of any one of Clauses 10-15, further comprising receiving a request to deploy a continuous training pipeline for a machine learning model, wherein the request specifies one or more triggering criteria.

Clause 17: The method of any one of Clauses 10-16, wherein the input data is received from a requesting entity, and the method further comprises: generating an output inference by processing the input data; and transmitting the output inference to the requesting entity, wherein the requesting entity stores the input data and a corresponding ground truth as new training data in the designated repository.

Clause 18: The method of any one of Clauses 10-17, wherein the request further specifies to deploy the machine learning model for one of batch inferencing or real-time inferencing.

Clause 19: The method of any one of Clauses 10-18, wherein automatically instantiating the inferencing pipeline for the machine learning model further comprises: retrieving a feature pipeline definition for the machine learning model, the feature pipeline definition indicating instructions for preprocessing input data for the machine learning model; and generating a feature pipeline based on the feature pipeline definition.

Clause 20: A system, comprising: a memory comprising computer-executable instructions; and one or more processors configured to execute the computer-executable instructions and cause the processing system to perform a method in accordance with any one of Clauses 1-19.

Clause 21: A system, comprising means for performing a method in accordance with any one of Clauses 1-19.

Clause 22: A non-transitory computer-readable medium comprising computer-executable instructions that, when executed by one or more processors of a processing system, cause the processing system to perform a method in accordance with any one of Clauses 1-19.

Clause 23: A computer program product embodied on a computer-readable storage medium comprising code for performing a method in accordance with any one of Clauses 1-19.

1. A method, comprising:
receiving a request to deploy a machine learning model, wherein the request specifies whether to deploy the machine learning model for batch inferencing or real-time inferencing;
in response to determining that a deployment pipeline for the machine learning model is not available, instantiating a deployment pipeline for the machine learning model, comprising:
retrieving a machine learning model definition from a registry containing trained machine learning model definitions;
validating the machine learning model definition using one more test exemplars; and
instantiating an inferencing pipeline including the machine learning model; and
processing input data using the inferencing pipeline.

2. The method of claim 1, wherein:
retrieving the machine learning model from the registry further comprises retrieving a feature pipeline definition for the machine learning model from the registry, the feature pipeline definition indicating how to preprocess input data for the machine learning model, and
instantiating the inferencing pipeline comprises generating a feature pipeline based on the feature pipeline definition.

3. The method of claim 2, wherein the request specifies to deploy the machine learning model for real-time inferencing, and the method further comprises:
receiving input data from a requesting entity;
generating prepared data by processing the input data using the feature pipeline;
generating an output inference by processing the prepared data using the machine learning model; and
providing the output inference to the requesting entity.

4. The method of claim 2, wherein:
the request specifies to deploy the machine learning model for batch inferencing, and
the request further specifies a storage location for the batch inferencing.

5. The method of claim 4, the method further comprising:
receiving input data from a requesting entity;
storing the input data at the specified storage location; and
in response to determining that one or more inferencing criteria are satisfied:
retrieving the input data from the specified storage location;
generating prepared data by processing the input data using the feature pipeline;
generating an output inference by processing the prepared data using the machine learning model; and
storing the output inference at the specified storage location.

6. The method of claim 1, further comprising:
receiving a second request to deploy the machine learning model; and
in response to determining that the deployment pipeline for the machine learning model is available:
refraining from instantiating a new deployment pipeline for the machine learning model based on the second request; and
instantiating a new inferencing pipeline, including a second instance of the machine learning model, using the deployment pipeline.

7. The method of claim 1, wherein validating the machine learning model definition comprises:
generating first output data by processing a first test exemplar using the machine learning model;
generating second output data by processing the first test exemplar using the machine learning model; and
verifying that the first output data matches the second output data.

8. The method of claim 1, wherein validating the machine learning model definition comprises:
processing a first test exemplar using the machine learning model, wherein the first test exemplar does not satisfy one or more model criteria specified in the registry; and
verifying that the inferencing pipeline returns an error for the first test exemplar.

9. The method of claim 1, further comprising:
receiving a plurality of machine learning model definitions;
receiving a plurality of configuration files for the plurality of machine learning model definitions; and
storing the plurality of machine learning model definitions and plurality of configuration files in the registry.

10.-20. (canceled)

21. A method, comprising:
receiving a request to perform continuous learning for a machine learning model, wherein the request specifies retraining logic comprising one or more triggering criteria;
automatically instantiating an inferencing pipeline including the machine learning model;
automatically instantiating the retraining logic, including the one or more triggering criteria;
processing input data using the inferencing pipeline; and
in response to determining that the one or more triggering criteria are satisfied, automatically:
using the retraining logic to retrieve new training data from a designated repository; and
using the retraining logic to generate a refined machine learning model by training the machine learning model using the new training data.

22. The method of claim 21, further comprising:
storing the refined machine learning model in a registry containing trained machine learning models; and
storing an indication that the refined machine learning model is ready for deployment.

23. The method of claim 22, further comprising:
automatically instantiating a new inferencing pipeline including the refined machine learning model; and
processing new input data using the new inferencing pipeline including the refined machine learning model.

24. The method of claim 23, wherein automatically instantiating the new inferencing pipeline including the refined machine learning model comprises retrieving the refined machine learning model from the registry.

25. The method of claim 22, further comprising:
generating performance metrics by evaluating the refined machine learning model using test data; and
storing the performance metrics in the registry.

26. The method of claim 21, wherein the designated repository is indicated in the request.

27. The method of claim 21, wherein the input data is received from a requesting entity, and the method further comprises:
generating an output inference by processing the input data; and
transmitting the output inference to the requesting entity, wherein the requesting entity stores the input data and a corresponding ground truth as new training data in the designated repository.

28. The method of claim 21, wherein the request further specifies to deploy the machine learning model for one of batch inferencing or real-time inferencing.

29. The method of claim 21, wherein automatically instantiating the inferencing pipeline for the machine learning model further comprises:
retrieving a feature pipeline definition for the machine learning model, the feature pipeline definition indicating instructions for preprocessing input data for the machine learning model; and
generating a feature pipeline based on the feature pipeline definition.

30.-35. (canceled)

36. A system, comprising:
a memory comprising computer-executable instructions; and
one or more processors configured to execute the computer-executable instructions and cause the system to perform an operation comprising:
receiving a request to perform continuous learning for a machine learning model, wherein the request specifies retraining logic comprising one or more triggering criteria;
automatically instantiating an inferencing pipeline including the machine learning model;
automatically instantiating the retraining logic, including the one or more triggering criteria;
processing input data using the inferencing pipeline; and
in response to determining that the one or more triggering criteria are satisfied, automatically:
using the retraining logic to retrieve new training data from a designated repository; and
using the retraining logic to generate a refined machine learning model by training the machine learning model using the new training data.

37. The system of claim 36, the operation further comprising:
storing the refined machine learning model in a registry containing trained machine learning models; and
storing an indication that the refined machine learning model is ready for deployment.

38.-40. (canceled)
